(19) United States
(12) Patent Application Publication
(10) Pub. No.: US 2021/0074184 A1
(43) Pub. Date: Mar. 11, 2021

(54) RETROPERITONEAL SURGICAL SIMULATION MODEL

(71) Applicant: Iman Alsaden, Chicago, IL (US)

(72) Inventor: Iman Alsaden, Chicago, IL (US)

(21) Appl. No.: 17/017,123

(22) Filed: Sep. 10, 2020

Related U.S. Application Data
(60) Provisional application No. 62/898,166, filed on Sep. 10, 2019.

(51) Int. Cl. G09B 23/30

(52) U.S. Cl. CPC G09B 23/30

(57) ABSTRACT

A retroperitoneal model includes a base, a pelvic bone body that is removeably attached the base, and one or more structures. The bone body includes a plurality of cavities and each structure includes a peg configured for insertion into one of the plurality of cavities. The one or more structures comprises a structure from the group of a psoas muscle structure, a genitofemoral nerve structure, a venous structure, an arterial structure, a ureteral structure, an obturator internus muscle structure, an obturator nerve structure, a film retroperitoneal tissue structure, and a peritoneum tissue structure.

### CROSS-REFERENCE TO RELATED APPLICATIONS

This application claims the benefit of U.S. Provisional Application No. 62/898,166 filed on Sep. 10, 2019, the entirety of which is incorporated herein by reference.

### BACKGROUND OF THE INVENTION

The present subject matter relates generally to surgical modeling systems. More specifically, the present invention relates to a retroperitoneal surgical simulation model.

The retroperitoneum is the space or cavity within the body outside the abdominal cavity between the peritoneum and the abdominal wall behind the abdomino-pelvic cavity. The retroperitoneum contains the pelvic vasculature, ureters, pelvic lymph nodes, nerves, and pelvic muscles.

Thorough familiarity with the area is necessary for correctly utilizing surgical techniques to maintain patient safety and to successfully complete surgical procedures. For example, pelvic cancer surgeries require exploration in the area, and it may be used as a surgical route to the base of the uterine artery in a scarred pelvis. However, many pelvic surgeons are unfamiliar with the retroperitoneum.

For example, retroperitoneal surgical procedures are used to create a surgical working cavity in the region of target tissue such as the aorta. One such procedure involves using a dissection balloon cannula in the retroperitoneum to access and dissect a cavity in the tissue adjacent the aorta. The cavity is maintained by mechanical or gas insufflation while securing a graft to the aorta. Other retroperitoneal procedures can be used to access the anterior portion of the spine more conveniently and less traumatically than through a large abdominal incision. Endoscopic approaches can be used to access the spine by transabdominal or the retroperitoneal procedure including transabdominal laparoscopic procedures. In the field of gynecologic oncology, accessing the retroperitoneal may be needed in order to remove cancerous lymph nodes that are found in the pelvic retroperitoneal spaces and para-aortically.

Learning surgical techniques and procedures is typically accomplished by studying texts regarding the surgeries, watching videos of surgeries, and observing surgeries in the operating room. Hands-on learning of surgical techniques is less common than needed to develop an expertise. For example, surgical students can assist surgeons, but there are not many opportunities for practicing surgical techniques without putting patients as risk.

Cadavers can be used to practice surgical techniques and procedures, but are problematic in that the use of cadavers is expensive, poses a risk to students by transmission of disease, and can be inaccessible and have variation in tissue quality. The costs associated with providing a cadaver lab and supporting personnel to staff the lab as well as performing the necessary safety and environmental protocol is often too expensive for hospitals and medical schools. Further, even if a cadaver is procured, only one surgical procedure can be performed for each surgical procedure area on the cadaver, as the procedure destroys the preserved tissue and surgical area. A new cadaver is therefore needed to repeat the procedure in the same surgical area, which is inefficient and not cost effective.

Accordingly, there is a need for a system for physicians and medical personnel to practice surgical skills and surgical procedures on the retroperitoneum, an important surgical area with multiple high risk areas.

### BRIEF SUMMARY OF THE INVENTION

To meet the needs above and others, the present disclosure provides a model system of the retroperitoneal area. The present system provides a retroperitoneal dissection model for medical fellows, residents, and attendings, among others, to practice surgical procedures. In an example, the retroperitoneal model system can be used for practice dissection of the retroperitoneal lymph nodes which are intimately related to vital structures such as pelvic arteries, veins and nerves. Various examples of the system are provided herein.

The retroperitoneal model includes a bone portion mounted on a stand and includes removable components and/or layers of structures to aid in visualization and spatial understanding. The model may include lymph nodes, pathologic (cancerous) lymph nodes, dense retroperitoneal connective tissue, and the peritoneal layer. The model may also include endometriotic implants penetrating the retroperitoneum, wherein the implants require entry into the retroperineum for resection. The present model may be combined with hysterectomy models or other models to provide a simulation for procedures utilizing other areas within the body that require entry into the retroperitoneum.

The present model can be made by any suitable means. For example, the system could be made by injection molding, three dimensional printing, among other methods.

In one embodiment, a retroperitoneal model includes a base, a pelvic bone body that is removeably attached the base, and one or more structures that attach to the bone body. The body includes one or more cavities for receiving the structures, and each of the one or more structures includes a peg for insertion into a cavity in the bone body.

In a further embodiment, the retroperitoneal model includes a psoas muscle structure and a genitofemoral nerve structure that removably engages with the psoas muscle structure. In a still further embodiment, the retroperitoneal model includes a venous structure including a large vein of the pelvic retroperitoneum that engages with the bone body. In other embodiments, the retroperitoneal model includes an arterial structure that engages with the bone body. The retroperitoneal model may include a ureteral structure, wherein the ureteral structure that engages with the bone body and the psoas muscle. The retroperitoneal model may include an obturator internus structure that engages with the bone body.

In further embodiments, the retroperitoneal model may include a film retroperitoneal tissue structure positioned over at least a portion of at least the psoas muscle structure, the genitofemoral nerve structure, the venous structure, the arterial structure, the ureteral structure, the obturator internus muscle structure, and the obturator nerve structure using an adhesive or other attachment means. In still further embodiments, the retroperitoneal model may include a peritoneum tissue structure positioned over the film retroperitoneal tissue structure, wherein the peritoneum tissue structure provides a translucent film layer.

An advantage of the present system is providing a life-like model of the retroperitoneal for medical training and practice.

A further advantage of the present system is providing a manufactured model that overcomes the disadvantages associated with hand-made models. For example, hand-made models lack realism, versatility, reproducibility, and accuracy.

An advantage of the present system is providing a teaching tool for pelvic retroperitoneal anatomy.

Another advantage of the present system is providing a recyclable model.

Another advantage of the present system is providing a model to test medical instruments.

The present model is different than a normal anatomical model because a user can perform surgical dissections on the model, in contrast to a non-interactive study of anatomy.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a front perspective view of an example of the present retroperitoneum model including a stand.

FIG. 2 is a side perspective view of the retroperitoneum model of FIG. 1.

FIG. 3 is a perspective view of an example of a bone body of the retroperitoneum model of FIG. 1.

FIG. 4 is a front perspective view of structures to be attached to the bone body of the retroperitoneum model of FIG. 1.

FIG. 5 is a front perspective view of dissection structures attached to the bone body of the retroperitoneum model of FIG. 1.

### DETAILED DESCRIPTION OF THE INVENTION

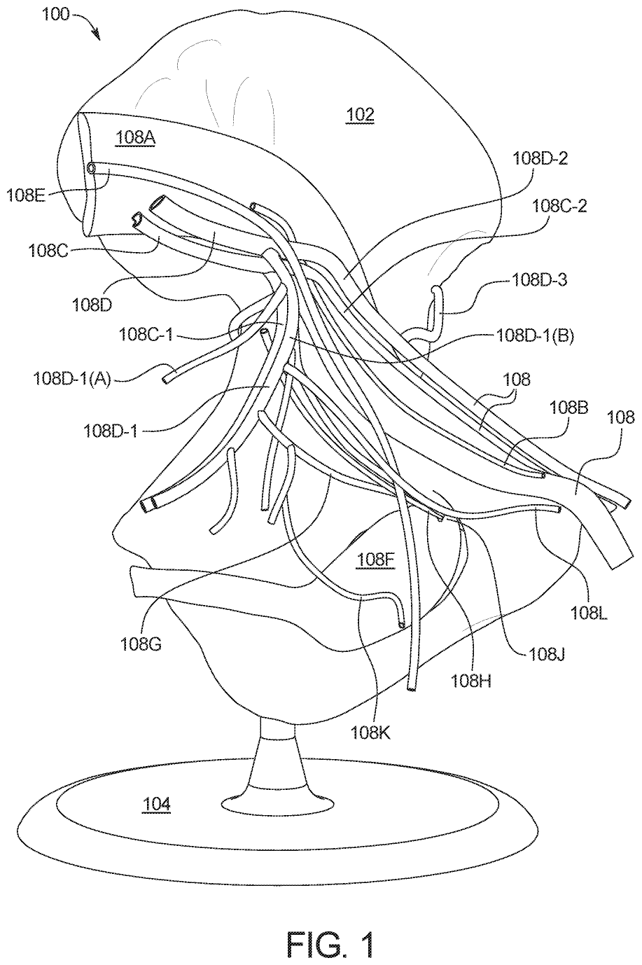

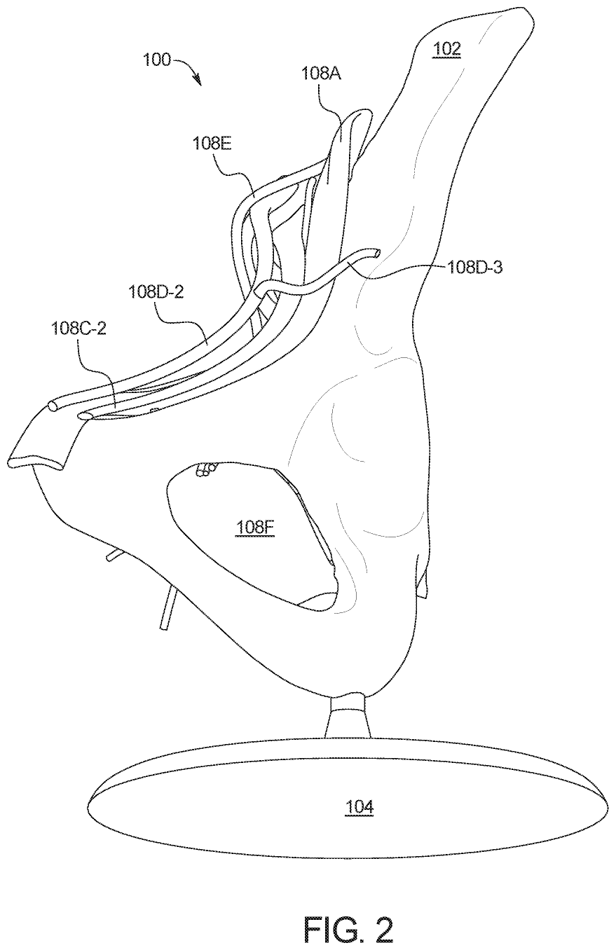

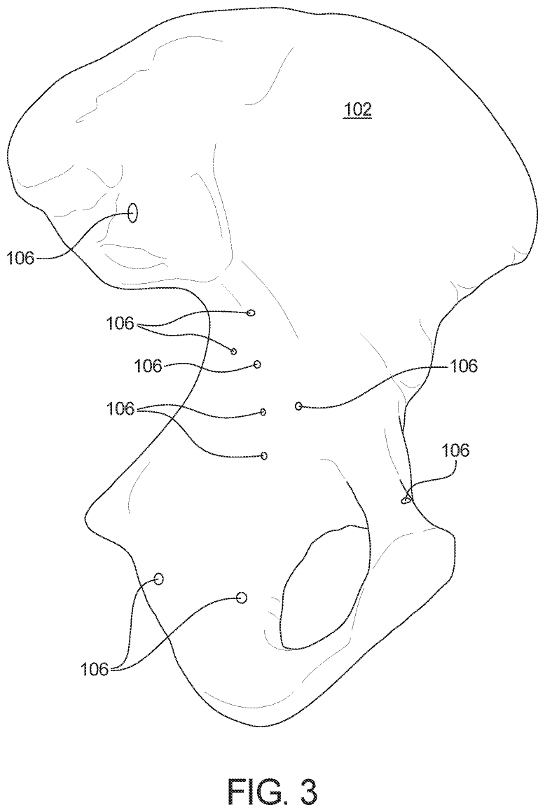

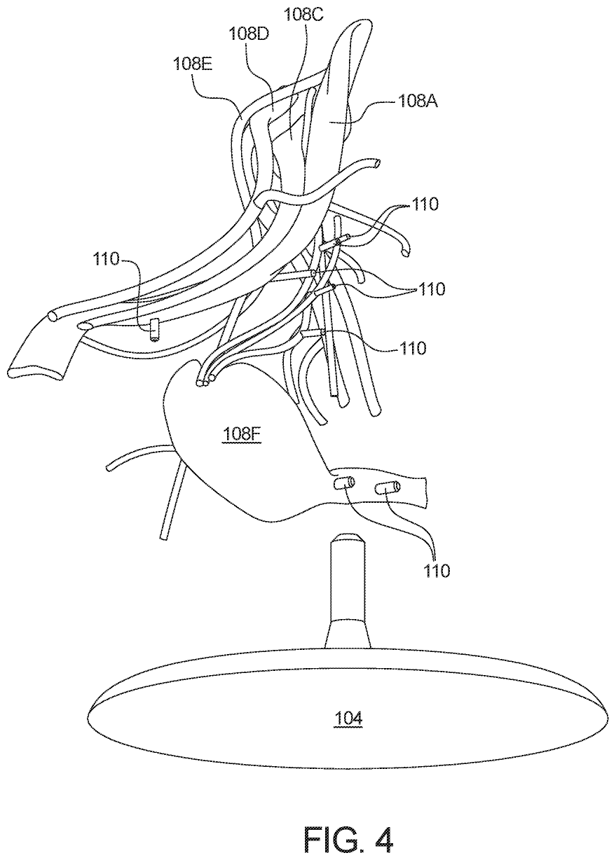

Referring to FIGS. 1-5, the present retroperitoneum model 100 includes a body 102 representing a bone mounted on a base 104 which may be attachable to a table. The body 102 may be a full pelvis or a hemipelvis and includes onto which structures 108, 112 such as arteries, veins, muscles, nerves, and ureter are attached. In the illustrated embodiment, the bone body 102 includes a plurality of cavities 106, as shown in FIG. 3. Each structure 108 includes at least one peg 110 that is inserted into the cavities 106 within the body 102, as shown in FIG. 4, or another structure 108. The structures 108 attach to the bone body 102 to form the full model 100 as shown in FIGS. 1 and 2.

At least one interior structure 108 is positioned within body 102 of a pelvic or hemipelvic member. The interior structure 108 may include artificial pelvic arteries (e.g., common iliac to distal branches), pelvic veins, muscles (e.g., psoas muscle), nerves (e.g., genital-femoral nerve), and additional vital structures (e.g., ureter). The interior artificial structures 108 can be detached and reattached to the body 102 for anatomical teaching purposes.

More specifically, the retroperitoneal model 100 may include a psoas muscle structure 108A and a genitofemoral nerve structure 108B that removably engages with the psoas muscle structure 108A.

The retroperitoneal model 100 may also include a venous structure 108C that engages with the bone body 102. The venous structure 108C may include the internal and external iliac vein structures 108C-1, 108C-2. The retroperitoneal model 100 may also include an arterial structure 108D that engages with the body 102. The arterial structure 108C may include the internal and external iliac artery structures 108D-1, 108D-2. The internal iliac artery structure 108D-1 may include a posterior division structure 108D-1(A) and an anterior division structure 108D-1(B). A deep circumflex iliac artery structure 108D-3 may also be included.

The retroperitoneal model 100 may include a ureteral structure 108E that engages with the bone body 102 and the psoas muscle structure 108A. The retroperitoneal model may include an obturator internus muscle structure 108F, an obturator artery structure 108G, an obturator nerve structure 108H, and an obturator vein structure 108J that engage with the bone body 102 and/or other structures 108.

The retroperitoneal model 100 may further include a uterine artery structure 108K and/or a superior vesicle artery structure 108L that engage with the bone body 102.

In further embodiments, the retroperitoneal model may include a film retroperitoneal tissue structure positioned over at least a portion of at least the psoas muscle structure, the genitofemoral nerve structure, the venous structure, the arterial structure, the ureteral structure, the obturator internus muscle structure, and the obturator nerve structure using an adhesive or other attachment means. In still further embodiments, the retroperitoneal model may include a peritoneum tissue structure positioned over the film retroperitoneal tissue structure, wherein the peritoneum tissue structure provides a translucent film layer.

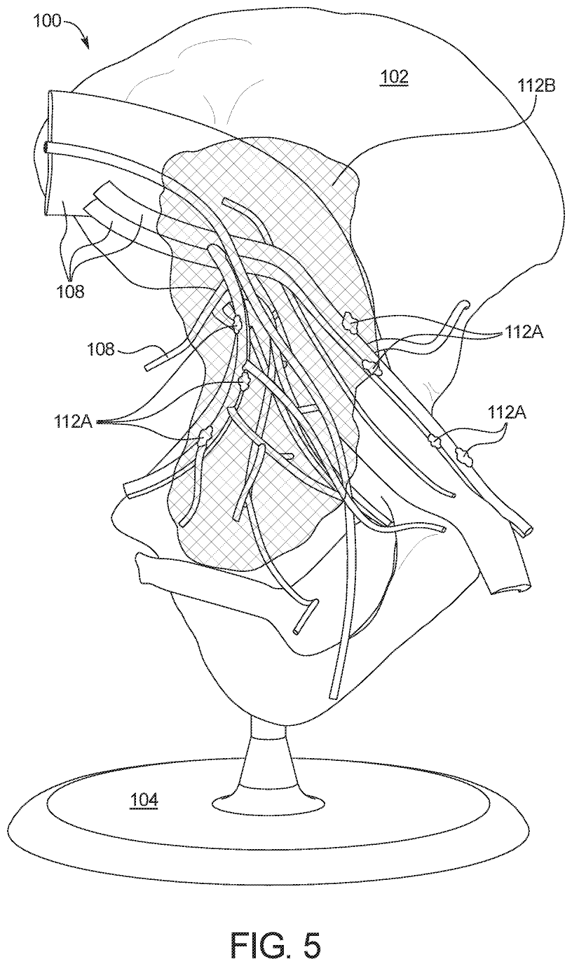

In some embodiments, the retroperitoneal model 100 may include dissection structures 112 to enable dissection. In the embodiment illustrated in FIG. 5, the dissection structures 112 include simulated lymph node material 112A inserted into cavities within the body 102 and concealed by a thin tissue material 112B to simulate the peritoneum. The model 100 may include optional arteries particular to models configured for the use of operating and/or dissecting, for example, the uterine artery base from the internal iliac.

The retroperitoneal model 100 can be used to can achieve a simulated surgery environment for an “open”, “laparoscopic”, or “robotic” approach. Moreover, the present model 100 can be combined with additional model materials such as the uterus, tubes, ovaries, bowel, bladder, or others in order to simulate a hysterectomy (via abdominal, laparoscopy, and/or robotic approach methods), complicated hysterectomy, or an alternative procedure where retroperitoneal entry is required to safely complete the procedure, such as a lymph node dissection.

The body 102 and inserted structures 108, 100 of the model 100 may be printed using three dimensional printing technology and/or injection modeled. The model 100 may be made of any suitable material including but not limited to plastic, natural rubber, and polymeric blends, among others. The bone body 102 and the structures 108, 112 may be made of a different materials than the remaining structures in order to simulate a more lifelike surgical dissection.

After 3D printing of the various structural elements, the elements may be assembled into the final model 100. Assembly includes organizing the layers of elements properly and securing them in place via their attachment points on the bone body. The next step in assembly includes adding the lymph node material, which can be made of a combination of polyester fill, adhesive, hydrogels, or alternative materials suitable for the application. Finally, the peritoneum can be placed over the entire retroperitoneal area to result in the final model that is then ready for use in surgical dissection teaching.

Numerous alterations, modifications, and variations of the preferred embodiments disclosed herein will be apparent to those skilled in the art, and they are all anticipated and contemplated to be within the spirit and scope of the claimed invention. For example, although specific embodiments have been described in detail, those with skill in the art will understand that the preceding embodiments and variations can be modified to incorporate various types of substitute, additional or alternative materials. Accordingly, even though only few variations of the present invention are described herein, it is to be understood that the practice of such additional modifications and variations and the equivalents thereof, are within the spirit and scope of the invention as defined in the following claims.

What is claimed is:

1. A retroperitoneal model comprising:
a base;
a bone body attached the base; and
one or more structures that attach to the bone body;
wherein the one or more structures comprises a structure from the group of a psoas muscle structure, a genitofemoral nerve structure, a venous structure, an arterial structure, a ureteral structure, an obturator internus muscle structure, an obturator nerve structure, a film retroperitoneal tissue structure, and a peritoneum tissue structure.

2. The retroperitoneal model of claim 1, wherein the bone body includes a plurality of cavities and each of the one or more structures includes a peg configured for insertion into one of the plurality of cavities.

3. The retroperitoneal model of claim 1, wherein the bone body comprises one of a full pelvis or a hemipelvis.

4. The retroperitoneal model of claim 1, wherein the one or more structures includes a psoas muscle structure and a genitofemoral nerve structure.

5. The retroperitoneal model of claim 1, wherein the one or more structures includes a venous structure and an arterial structure.

6. The retroperitoneal model of claim 5, wherein the venous structure comprises internal and external iliac vein structures.

7. The retroperitoneal model of claim 5, wherein the arterial structure comprises internal and external iliac artery structures.

8. The retroperitoneal model of claim 1, wherein the one or more structures includes an obturator internus muscle structure.

9. The retroperitoneal model of claim 1, wherein the one or more structures includes an obturator internus muscle structure.

10. The retroperitoneal model of claim 1, further comprising one or more lymph node structures connected to one of the bone body and the one or more structures.

11. The retroperitoneal model of claim 10, wherein the one or more lymph node structures is comprised of polyester fill, adhesive, or hydrogel.

12. The retroperitoneal model of claim 11, further comprising a layer of material across the one or more lymph node structures on the bone body.
